(19) United States
(12) Patent Application Publication
(10) Pub. No.: US 2008/0030043 A1
(43) Pub. Date: Feb. 7, 2008

(54) Cover

(75) Inventor: Werner Camps, Antwerp (BE)

Correspondence Address: HARNESS, DICKEY & PIERCE, P.L.C., P.O. BOX 828, BLOOMFIELD HILLS, MI, 48303, US

(73) Assignee: CONTEYOR MULTIBAG SYSTEMS N.V., MERELBEKE (BE)

(21) Appl. No.: 11/597,490

(22) PCT Filed: Apr. 29, 2005
(86) PCT No.: PCT/EP05/51958

§ 371 Date: Jun. 6, 2007

(30) Foreign Application Priority Data
May 28, 2004 (DE) 20-2004-008-537.2

(51) Int. Cl. B60J 11/00

(52) U.S. Cl. 296/98

(57) ABSTRACT

The invention relates to a cover for a container opening (2), comprising a rotatable roll (9) and a flexible web (6). The roll (9) is fixed to one of the sides of the opening while the first end of the flexible web that can be rolled onto the roll is fastened to the roll. In order to create a cover for a container opening which overcomes the disadvantages of said previously known cover while being inexpensive and easy to produce, a frame (11) which has substantially the same size as the flexible web (6) is fixed within the opening (2). Said frame (11) or parts thereof as well as the flexible web (6) are provided with one respective element of an adhesive closure (10) along the circumference thereof or parts of said circumference such that the same can be connected to each other and the flexible web (6) closes the opening (2).

The present invention concerns a cover for a container opening, comprising a rotatable roll and a flexible web, wherein the roll is fixed at one of the sides of the opening and wherein the first end of the flexible web which can be rolled on to the roll is fixed to the roll.

Covers for container openings, in particular piece good containers for various components in the automobile industry, which close openings by means of roller blinds, are known from the state of the art. In that respect inter alia roller blinds in the nature of a spring-loaded roller blind as are known from window openings are used, wherein the roller blind can be wound on to a roll which is prestressed by means of a torsion spring and the roll latches into different latching positions when the curtain is pulled down. A disadvantage in that respect is that the curtain when in the pulled-down position only inadequately closes the container opening as it only hangs in front of the opening and for example in the event of movement or when the container is in an inclined position the curtain stands away from the container opening so that dirt, dust and moisture can penetrate into the container opening. Roller blinds for closing a container opening are also known from the state of the art, in which the roll is also prestressed with a torsion spring for rolling up the curtain but the curtain is held in its closed position by means of hooks which engage into the curtain or members secured thereto. It is possible in that way to prevent the curtain from standing away from the container opening when the container is in an inclined position. However even with that structure there still remains an adequate spacing between the curtain and the frame of the transport container so that dirt, dust and moisture can penetrate into the interior of the container, even when the curtain is closed. Possible solutions to that problem are offered by roller blind systems which guide the curtain in a direction perpendicularly to the rotatable roll in a frame and seal it off. Such guide arrangements however are structurally complicated, expensive and susceptible to wear.

In comparison with that known state of the art the object of the present invention is to provide a cover for a container opening, which overcomes the above-mentioned disadvantages and which is nonetheless inexpensive and simple to produce.

To attain that object, there is provided a cover for a container opening comprising a rotatable roll and a flexible web, wherein the roll is fixed at one of the sides of the opening and wherein the first end of the flexible web which can be rolled on to the roll is fixed to the roll, and wherein a frame is fixed within the opening and the frame and the flexible web are of substantially the same size and wherein the frame or parts thereof and the flexible web or parts thereof are respectively provided with a respective member of an adhesive closure so that they can be connected together and the flexible web closes the opening. In that respect hereinafter the term adhesive closure is used to denote a connection between the cover and the frame in the manner of a re-detachable and re-closable adhesive connection, for example by means of a re-usable adhesive layer.

Such an adhesive closure is inter alia and preferably also a magnetic closure, wherein a respective magnetic material is connected to each of the cover and the frame. If the frame itself comprises a ferromagnetic material, for example steel, and if the cover is provided with a flexible strip of a magnetised material, the cover can be connected to the frame. Magnetic strips of that kind which can even be sewn are commercially available. The frame itself is then part of the closure and does not have to have an additional part. Alternatively the frame could have integrated magnets, for example in strip form, while the edges of the cover would be provided with a steel strip or the like.

In a further particularly preferred embodiment of the invention the closure is a hook-and-loop fastener.

Such a configuration of the invention is expedient as it makes it possible for the curtain formed by the flexible web to be connected to the frame firmly and sealingly within the container opening at all sides of the container opening. The curtain formed by the flexible web can be made for example from fabric webs, non-woven fabric-like materials but also film or foil materials or composite materials such as for example coated fabric webs. The frame which is fitted within the container opening and to which the curtain can be connected by means of a closure makes it possible for the curtain in the closed condition to lie within the dimensions of the transport container so that it is at least partially protected from damage which can occur if the curtain is fixed directly to the outside of the container. It is essential that the curtain and the frame are provided with the opposite parts of the closure so that the members can be connected together.

A preferred embodiment of the invention is one in which the closure is line-shaped or strip-shaped. Such strip-shaped closures have the advantage over point-form closures, for example press studs, that they form a sealing connection between the cover and the frame while for example in the case of press studs moisture or dirt can pass into the interior of the container through the intermediate spaces between the individual studs. A preferred embodiment of the invention is one in which the rotatable roller and the closure are so designed that in the rolled-up condition in the region of the closure the thickness of the layers of web is less than three times and preferably less than twice the thickness of the layers of web in the central region. That therefore avoids the web building up into a thick rigid accumulation of material in the edge regions of the rolled-up flexible web while the regions of the flexible web, which are between the edges, are only loosely wound.

A particularly preferred embodiment in that respect is one in which the diameter of the roll is at least 5% and preferably at least about 8% of the unrollable length of the flexible web. Thus the entire flexible web can be rolled on to the roll in only 5 or 4 windings respectively.

As an alternative for reducing the windings on the roll, an embodiment of the invention which is expedient is one in which the part of the closure which is fixed to the flexible web is so designed that the individual portions of the closure, after the web is rolled on to the roll, do not lie upon each other or only partially lie upon each other in the radial direction. For that reason, in this embodiment the closure at the flexible web is in the form of a strip which in a limited region at the edge of the web meanders or extends in an s-shaped configuration in the unrolling direction or which however extends in a straight line at a shallow angle relative to the frame and to the edge of the flexible web respectively. It is advantageous in both cases if the part of the closure which is fitted to the frame member within the container opening or to the brace members of the container is of a width which corresponds to the maximum spacing of the inner edge of the closure strip from the edge of the flexible web. As an alternative thereto a possible embodiment is one in which the part of the closure which is fixed to the frame or the brace members is also strip-shaped and follows the configuration of the closure on the flexible web. A possible embodiment is also one in which the lateral delimitation of the flexible web follows the configuration of the closure strip.

In that respect it is desirable if the hook-shaped members of the hook-and-loop fastener are sewn to the curtain while the s-shaped members of the hook-and-loop fastener are glued or riveted to the frame.

In that respect a particularly preferred embodiment is one in which the flexible web is provided along its circumference with a part of the closure. In that respect it can be desirable if no closure is provided along the first end of the flexible web, which is fixed to the roll, as in that region of the container opening the flexible web can only be lifted away from the frame with difficulty when opening the curtain. For the same reason it is advantageous if the parts of the closure along the sides perpendicularly to the first and second ends of the web terminate between 5 and 20 cm, preferably between 10 and 18 cm and particularly preferably 15 cm before the first end of the flexible web. In that way the curtain can be easily separated from the frame and is not impeded when being rolled on to the roll. In addition it may be desirable if an edge reinforcement is provided at the second end of the flexible web, for example in the form of a substantially rigid rod or a flexible bar, in parallel relationship with the edge of the web. That permits easier actuation of the curtain even with one hand.

It is advantageous in that respect if the second end of the flexible web and the lower end of the frame each have at least one respective member of a safety closure. The safety closure prevents the flexible cover coming loose from the frame during transport and opening the opening. Such a safety closure is preferably a press stud closure or an eyelet closure. In the case of the eyelet closure at least one hook which is connected to the frame engages through a preferably reinforced elongate eyelet in the flexible web. The hook can subsequently be turned so that it holds the cover to the frame. Alternatively or additionally an additional safety line can be threaded through the hook which prevents the cover from coming loose from the hook. A further variant of a safety means would be an eyelet closure which comprises slots on the curtain, through which rotatable flat studs or eyelets which are fixed to the oppositely disposed part are passed in a first orientation and then turned, in which respect they pass through the slots only in the first orientation.

A preferred embodiment of the present invention is one in which the roller is prestressed with a torsion spring in such a way that the flexible web can be rolled on to the roll under spring actuation. Thus, after having been lifted away from the frame, the flexible web can be rolled up by simply being released and the container can be opened. In that respect it is also appropriate for a flexible pull member to be fixed to the second end of the flexible web, with which the curtain can be pulled down from the roll for closing the container opening.

Further features, advantages and uses of the present invention will be clearly apparent from the embodiment described by way of example hereinafter and the accompanying drawings.

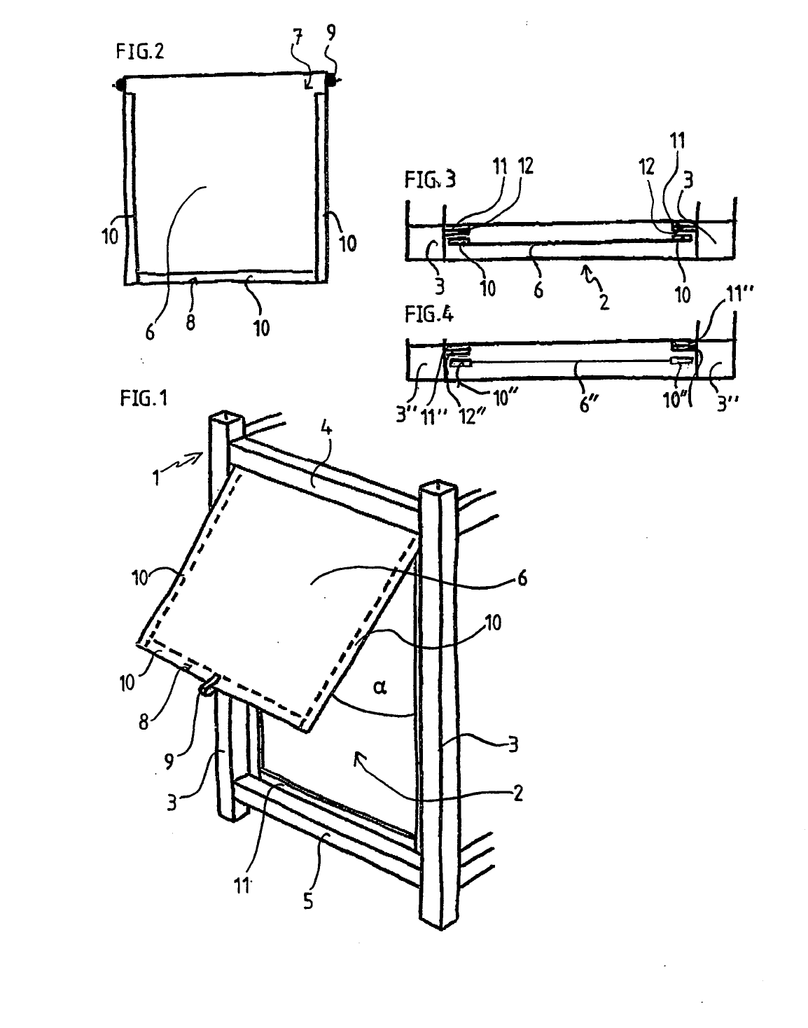

FIG. 1 shows a three-dimensional view of a cover according to the invention for a container opening,

FIG. 2 is a view of the cover according to the invention from the rear,

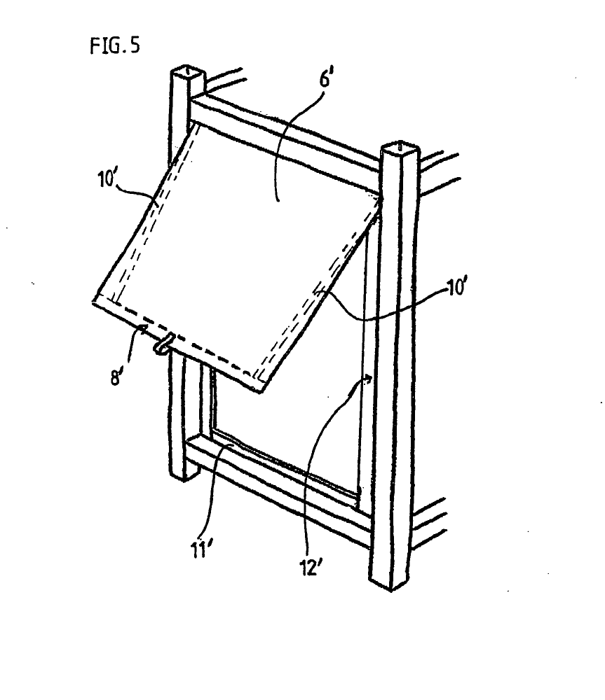

FIG. 3 is a vertical view in section through the container cover according to the invention,

FIG. 4 is a vertical view in section through a second embodiment of the container cover,

FIG. 5 shows a three-dimensional view of a further embodiment, and

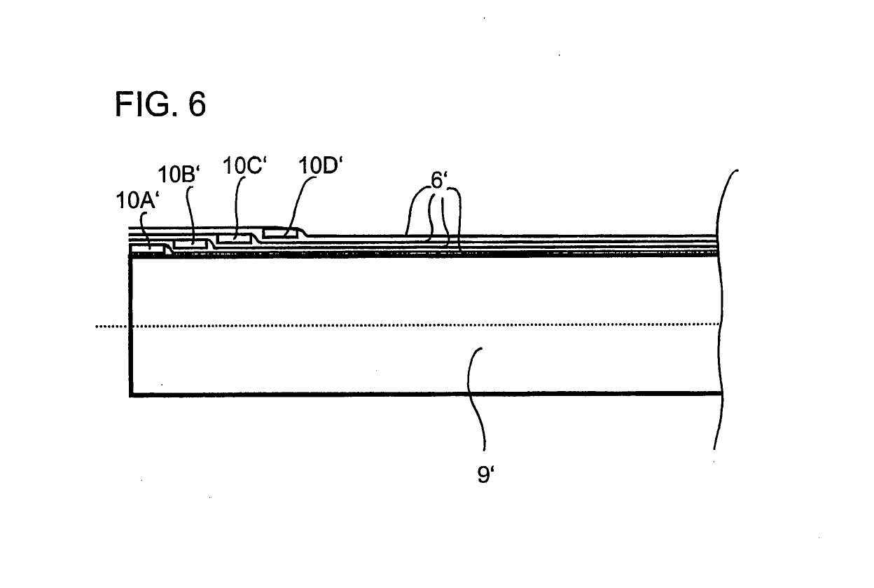

FIG. 6 shows a broken-away side view in section through the web of FIG. 5 rolled on to the roll.

FIG. 1 shows a three-dimensional view of one side of a transport container 1 for piece goods. The container opening 2 is formed by a frame structure 3 with side, upper and lower load-bearing profile members.

To close the container opening 2, there is provided a curtain 6 comprising a flexible web, the curtain being of substantially the same size as the container opening 2. The flexible web 6 is fixed with its upper end 7 to a rotatable roll 9 in the region of the upper brace member 4. In that case the curtain formed by the flexible web 6 can be rolled on to the roll 9.

In the illustrated embodiment the roll 9 is prestressed with a torsion spring so that the curtain can be rolled on to the roll with spring actuation and to close the container opening 2 can be unrolled against the restoring spring force of the roll 9.

A flexible bar is fitted to the lower end 8 of the flexible web 6 in parallel relationship with the edge of the web. The bar makes it possible for the flexible web 6 to be pulled downwardly uniformly over the entire width even with one hand and thus sealingly close the container opening 2. A pull member 9 comprising a flexible web material is also fixed to the lower end 8 of the flexible web 6, which makes it possible to grip the curtain, unwind it comfortably from the roll 9 and thus close the container opening 2.

As indicated in FIG. 1 and as can be clearly seen from FIG. 2 the sides and the lower end 8 of the flexible web 6 are provided with the hook part of a hook-and-loop fastener 10. For the purposes of closing the container opening 2, provided in the container opening 2 is a frame member 11 which comprises metal profile members of a rectangular cross-section (20×3 mm) which are welded to the lateral brace members 3 and the lower brace member 5 of the container. In other embodiments, a further profile member can be fixed to the upper brace member 4 of the container. The frame member 11 overlaps with the curtain 10 in the condition of being pulled down, at the lower side and at the sides. The loop portion 12 of a hook-and-loop fastener is fixed by glueing to the outwardly facing surface on the frame element 11. When now the flexible web 6 is pulled down to close the container opening 2, the hook portion 8 of the hook-and-loop fastener comes into engagement with the loop portion 12 of the hook-and-loop fastener, which is fixed to the frame member 11, after the flexible web 6 is pressed against the frame member 11. In that way, not only is the curtain held in front of the container opening 2 against the spring force of the roll 9, but the container opening 2 is also closed in dust-tight and dirt-tight relationship. The hook-and-loop fastener even affords a certain protection from moisture.

It will be seen from FIG. 1 that the roll 9 is arranged in the upper brace 4 of the container in a condition of being protected from influences from the exterior. By virtue of that arrangement of the roll 9 within the container opening, it is necessary for the frame member 11 to be fitted within the container opening in order to be able to close the container with the flexible web 6. Alternatively to the illustrated embodiment, the flexible web 6 can be guided out through a slot on the front side of the brace member 4. If that slot extends into the vertical brace members 3 and if the roll and the flexible web are also of a corresponding width, then the portion of the hook-and-loop fastener, which is fixed on the flexible web, can be brought into engagement with a counterpart portion of the hook-and-loop fastener which is fixed directly to the brace members.

The closure principle of the illustrated embodiment will be particularly clearly apparent once again in FIG. 3 showing a horizontal section through the container opening 2. It is possible to see therein the vertical brace members 3 as well as the frame member 11 which is mounted within the container opening. It is possible to see on the frame member 11 the loop portion 12 of the hook-and-loop fastener which can be brought into engagement with the hook portion 10 which is fixed to the flexible web 6.

FIG. 4 also shows a horizontal section through an alternative embodiment in which hook portions 10″ of the hook-and-loop fastener are fined laterally to the flexible web 6″ so that, in the region of the hook-and-loop fasteners 10″, there is a lesser thickness in respect of the wound-up roll portions.

As an alternative to the hook portion 10 of the hook-and-loop fastener extending as shown in FIG. 2 along the side edges of the flexible web 6 into the region of the upper end 7 of the flexible web 6, the hook portion of the hook-and-loop fastener can also be of such a dimension that a spacing of about 15 cm remains in relation to the upper end 7 of the flexible web 6. Such a configuration of the invention makes it possible for the container opening 2 which is already closed to be opened more easily as the hook-and-loop fastener does not extend over the entire height of the container and thus the flexible web can be opened at a smaller angle α with respect to the container opening 2.

The embodiment of the invention shown in FIG. 5 comprises a cover for a container opening 2′, wherein the hook portion 10″ of the hook-and-loop fastener, which is fixed to the flexible web 6′, is arranged in strip form in the edge region of the flexible web 6′ in such a way that it includes a shallow angle with the edge of the flexible web 6′. In that arrangement the configuration of the hook-and-loop fastener strip is such that, at the lower end 8′ of the flexible web 6′, it is at a spacing of about 5 cm from the edge of the flexible web 6′. Accordingly the frame member 11′ and the loop portion 12′ fixed thereto are of a width of about 5 cm and the hook portion 10′ of the flexible web 6′ is of a width of about 1 cm.

In that way the portions of the hook-and-loop fastener strips 10′ of the flexible web 6′ lie only partially one upon the other in the radial direction after the curtain is rolled up, and the thickness of the rolled-up portions on the roll is greatly reduced in comparison with embodiments in which the individual portions of the hook-and-loop fastener strip are disposed directly one upon the other radially, after the winding-up operation. That can be clearly seen from FIG. 6 which shows a broken-away diagrammatic view in section through the web 6′ which is rolled up on to the roll 9′. In the illustrated section the individual portions 10A′, 10B′, 10C′ and 10D′ are in mutually juxtaposed relationship.

### LIST OF REFERENCES

1 transport container
2 container opening
3 frame structure
4 upper brace member
5 lower brace member
6 curtain/flexible web
7 upper end
8 lower end/hook portion
9 roll/pull member
10 hook-and-loop fastener/hook portion
11 frame member
12 loop portion

1. A cover for a container opening comprising a rotatable roll and a flexible web that can be rolled on the roll, wherein the roll is fixed to the container having the opening at a side of the opening and wherein a first end of the flexible web is fixed to the roll, wherein a frame is fixable within the opening, wherein the frame and the flexible web are of substantially the same size and at least a portion of a periphery of the frame and at least a portion of a periphery of the flexible web have respective members of a closure so that the respective closure members of the flexible web and the frame can be connected together so that the flexible web closes the opening.

2. A cover for a container opening according to claim 1 wherein the closure is a magnetic closure.

3. A cover for a container opening according to claim 1 wherein the closure is a hook-and-loop fastener.

4. A cover for a container opening according to claim 1, wherein when the flexible web is rolled-up on the roll a thickness of layers of the flexible web in a region of the closure member of the flexible web is less than three times a thickness of layers of web in a central region of the web.

5. A cover for a container opening according to claim 1, wherein the closure member of the flexible web is fitted to the flexible web.

6. A cover for a container opening according to claim 1, wherein a diameter of the roll is at least 5% of an unrollable length of the flexible web.

7. A cover for a container opening according to claim 1, wherein a portion of the flexible web's closure member extends at a shallow angle with respect to a lateral boundary of the container opening.

8. A cover for a container opening according to claim 1, wherein the flexible web's closure member extends in an s-shape.

9. A cover according to claim 3, wherein the closure members are loop and hook members of the hook-and-loop fastener, the loop member fixed to the frame and the hook member fixed to the flexible web.

10. A cover according to claim 1, wherein the closure member of the flexible web is not provided on the first end of the flexible web.

11. A cover according to claim 1, wherein portions of the closure member along sides of the flexible web that extend perpendicularly to the first end of the flexible web terminate between 5 and 20 cm in front of the first end of the flexible web.

12. A cover for a container according to claim 1, wherein the flexible web has a second end opposite and parallel to the first end, the second end of the flexible web having at least one of a substantially rigid bar or a flexible bar mounted thereto and extending therealong.

13. A cover for a container according to claim 1, wherein the flexible web has a second end opposite and parallel to the first end and the frame has a lower end, the second end of the flexible web and the lower end of the frame each have at least one respective member of a safety closure.

14. A cover for a container according to claim 1, wherein the roll is prestressed with a torsion spring in such a way that the flexible web can be rolled up under spring actuation.

15. A cover for a container according to claim 1, wherein a flexible pull member is fixed at a second end of the flexible web, the second end of the flexible web opposite to and parallel to the first end.

16. A cover for a container according to claim 1, wherein the roll is arranged in a plurality of brace members forming the container opening.

17. A cover for a container according to claim 1, wherein when the flexible web is rolled-up on the roll, the thickness of the layers of the flexible web in the region of the closure member of the flexible web is less than twice the thickness of the layers of the web in the central region of the web.

18. A cover for a container opening according to claim 1, wherein the diameter of the roll is at least 7.9% of the unrolled length of the flexible web.

19. A cover for a container opening according to claim 11, wherein the portions of the closure member along the sides of the flexible web that extend perpendicularly to the first end of the flexible web terminate between 10 and 18 cm in front of the first end of the flexible web.

20. A cover for a container opening according to claim 19 wherein the portions of the closure member along the sides of the flexible web that extend perpendicularly to the first end of the flexible web terminate 15 cm in front of the first end of the flexible web.

21. A cover for a container opening according to claim 11, wherein a portion of the flexible web's closure member extends at a shallow angle with respect to a lateral boundary of the container opening.

22. A cover for a container according to claim 13 wherein the respective members of the safety closure include a press stud and an eyelet closure.
